(19) United States
(12) Patent Application Publication
(10) Pub. No.: US 2003/0042702 A1
(43) Pub. Date: Mar. 6, 2003

(54) Bicycle shock absorber enhencement

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/945,640

(22) Filed: Sep. 5, 2001

(51) Int. Cl. B62K 3/00

(52) U.S. Cl. 280/283; 280/288

(57) ABSTRACT

A bicycle shock absorber enhancement comprises a seat pipe having its top connected to a cushion, and its rear portion secured with a connector, which secures the upper portion of a shock absorber. The seat pipe has its low end secured to a rear fork of the bicycle frame, which has a rear wheel secured thereat. The rear fork of the bicycle comprises a reinforcing rib to receive and support the lower end of the shock absorber to reinforce its shock absorbing ability.

### BACKGROUND OF THE INVENTION

1. Field of the Invention

This invention relates to a shock absorber for a bicycle, and more particularly to reinforce the structure of the shock absorber.

2. Description of the Relative Prior Art

A conventional bicycle is to install wheels at the front and the rear lower ends of a frame and a shock absorber being secured to the frame and a fork, respectively. This design is to lift the shock absorber up when running on an uneven road to minimize the uncomfortable feeling. However, due to the shock absorber is supported merely by the fork and the frame, it may fatigue after a certain time.

### SUMMARY OF THE INVENTION

It is the primary object of the present invention to provide a shock absorber for a bicycle, which provides a comfortable way of riding bicycle.

It is another object of the present invention to provide a shock absorber for a bicycle, which is easy to install.

It is a further object of the present invention to provide a shock absorber for a bicycle, which is inexpensive to manufacture.

### BRIEF DESCRIPTION OF THE DRAWINGS

FIG. 1 is an exploded view of a bicycle incorporated with the present invention; and

FIG. 2 is a side cross section view of FIG. 1.

### DETAILED DESCRIPTION OF THE PREFERRED EMBODIMENT

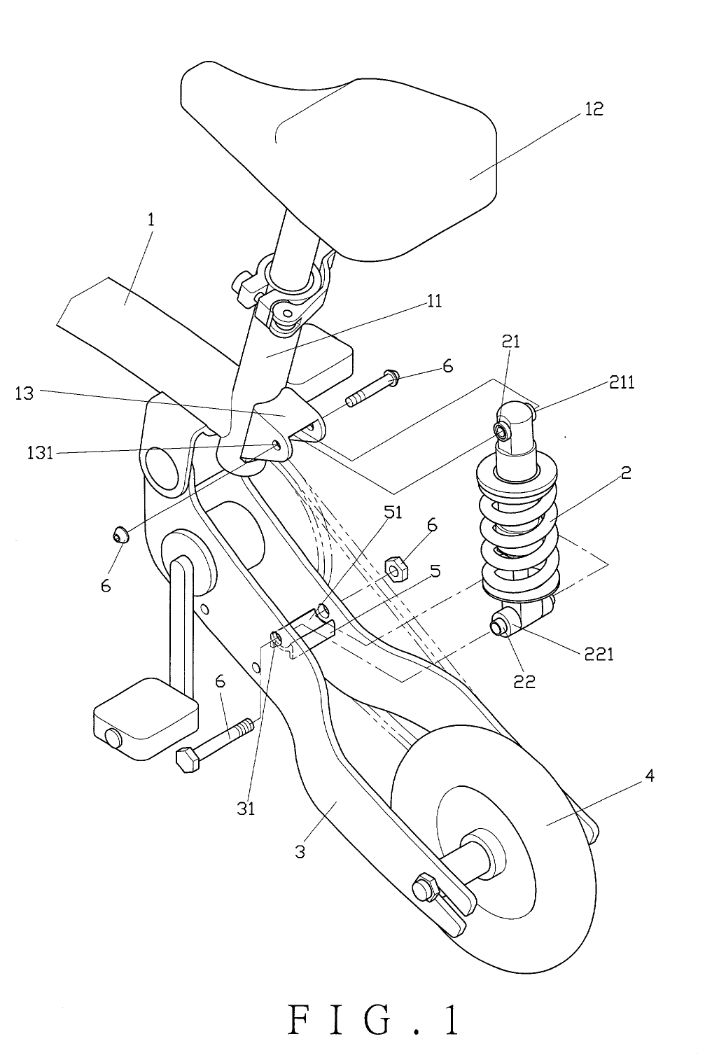

As shown in FIG. 1, a seat pipe 11 of a bicycle 1 has a cushion 12 connected to its top end, and the rear portion of the seat pipe 11 has a connector 13 to secure the top end of a shock absorber 2 by means of inserting a fastener 6 through holes 131 on the connector 13. The bottom end of the seat pipe 11 is secured with a two parallel fork-shaped rear frame 3 and a rear wheel 4 to the end of the frame 3.

The rear frame 3 has a pair of holes 31 for a fastener 6 to insert through there and to secure a U-shaped reinforcing rib 5, which is welded to the inner wall of the rear frame 3 for supporting the lower end of the shock absorber 2.

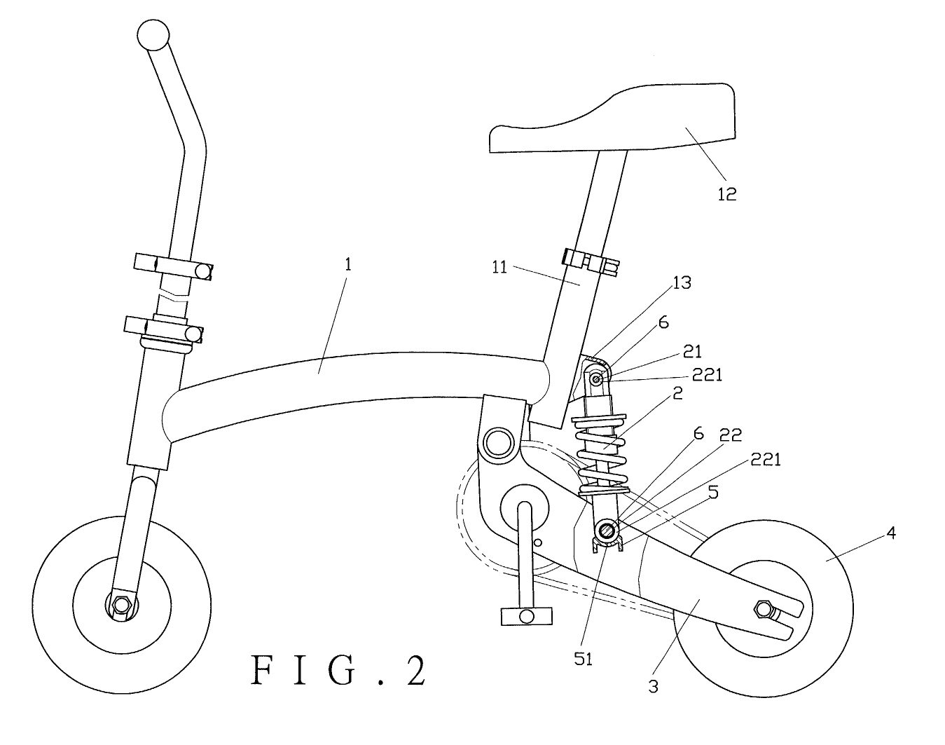

To assemble the shock absorber 2, as shown in FIG. 2, an upper shaft 21 of the shock absorber 2 is secured to the holes 131 of the connector 13 by means of inserting the fastener 6 through a pair of washers 211 on respective sides of the upper shaft 21. Due to the sealed top end of the connector 13, the top end of the shock absorber 2 engages with the top end of the connector 2 as a support. An lower shaft 22 and washers 221 are also secured by the fastener 6 through the holes 31 to the rear fork 3, to support the bottom end of the shock absorber 2 along with the reinforcing rib 5.

When riding on an uneven road, the rear fork 3 may be lifted which brings the shock absorber 2 upwardly, since the lower shaft 22 and the washers 221 of the shock absorber 2 are secured to the reinforcing rib 5, the shock absorber 2, at this moment, will be depressed. The reinforcing rib 5 absorbs most of the stress from the depressing force, which prevents the hole 31 from deterioration. The upper shaft 21 also has its top end engaging with the inner closed end of the connector 13, which prevents the hole 131 from deterioration as well.

I claim:

1. A bicycle shock absorber enhancement comprising a cushion secured to a top end of a seat pipe of said bicycle, having a rear fork secured to its rear end for connection of a wheel thereat, and a connector secured to a bottom portion of said seat pipe for securing an upper end of a shock absorber thereat, whereas a lower end of said shock absorber being secured to said rear fork, and is characterized in that,
said connector having a sealed top end, and said rear fork comprising a reinforcing rib as an auxiliary supporting of the lower end of said shock absorber.

2. The bicycle shock absorber enhancement, as recited in claim 1, wherein said reinforcing rib having an arcuate surface for the lower end of said shock absorber to seat therein.
